(19) United States
(12) Patent Application Publication
(10) Pub. No.: US 2002/0114439 A1
(43) Pub. Date: Aug. 22, 2002

(54) User transparent internet telephony device and method

(76) Inventor: John H. Dunlap, Ann Arbor, MI (US)

Correspondence Address: BRINKS HOFER GILSON & LIONE, P.O. BOX 10395, CHICAGO, IL, 60610, US

(21) Appl. No.: 10/054,015

(22) Filed: Jan. 22, 2002

Related U.S. Application Data
(60) Provisional application No. 60/262,719, filed on Jan. 19, 2001.

(51) Int. Cl. H04M 7/00; H04L 12/66

(52) U.S. Cl. 379/219; 370/352

(57) ABSTRACT

A telephone gateway device that operates in a manner transparent to calling and called parties is provided. The gateway includes a port for connecting one or more POTS devices, a port for connecting to a local PSTN, a modem, and a network interface. The gateway selectively routes toll calls made on an attached POTS device over a computer network, such as the internet, via either the modem or the network interface. Methods of routing and facilitating telephone connections over a computer network are also provided.

### REFERENCE TO PREVIOUS APPLICATION

This application claims the benefit of U.S. Provisional Application No. 60/262,719 filed on Jan. 19, 2001.

### FIELD OF THE INVENTION

The present invention relates to an internet telephony device and an internet telephony system. More specifically, the invention relates to an internet telephone gateway that selectively routes telephone calls across a public switched telephone network (PSTN) and a computer network, such as the internet.

### BACKGROUND OF THE INVENTION

Several new technologies are impacting various sectors of the telecommunications industry, including the long distance telephone and internet access sectors. One of these new technologies is internet telephony, with one particular implementation being voice over internet protocol (VoIP). Internet telephony allows for the routing of telephone conversations over the internet instead of routing across the conventional telephone network.

Traditionally, long distance telephone calls have used plain old telephone system (POTS) telephone devices and the public circuit switched inter-exchange (IXC's) (AT&T, Sprint, and MCI Worldcom are a few examples of IXC's). These conventional long distance telephone calls comprise two segments: a local segment and a long distance segment. The local segment represents a connection between the POTS telephone and a local exchange carrier (LEC), while the long distance segment represents connections made by the transmission and switching facilities of an IXC. As a result of this two segment arrangement, traditional toll charges for long distance calls typically have at least two components, including an LEC charge and an IXC charge. Toll charges for the IXC segment may be based on calling time and distance and therefore may be considerably more expensive depending on the distance between the calling and called parties.

The internet has grown to a global high speed data network with worldwide points of access. As such, the internet represents a potential alternative to the telephone call routing structure described above. Indeed, personal computer (PC) users with appropriate hardware and software can hold long distance telephone conversations by sending digitzed voice data between two parties. This internet telephony permits a long distance telephone conversation to occur over the internet as opposed to the typical long distance call as detailed above. Accordingly, users owning PC's that are outfitted with internet voice software and special sound generating boards and microphones may carry on long distance telephone conversations for the cost of a local internet connection, thereby effectively obtaining free and/or low cost long distance service. Data packets generally are far more efficient and thus less costly to transmit than voice over switched channels (“virtual circuits”).

VoIP, a specific embodiment of internet telephony, works by converting analog voice into a digital format and sending digital voice data packets over the internet or other communications network. The voice packets are compressed and decompressed using various algorithms (called “CODECS”). Each end of the telephone call, i.e., the sender and receiver, must use the same compression/decompression systems and/or algorithms. International standards for CODECS exist today. Also, standards exist for the routing and control information associated with VoIP data packets. The most popular of these standards is the international telecommunications union (ITU) H.323 protocol. Other examples of these protocols include session initiation protocol (SIP) and media gateway control protocol (MGCP).

To date, internet telephony has not gained wide spread acceptance, likely because the use of conventional VoIP software on a PC to accomplish internet telephony has several drawbacks. First, it requires the user to initiate calls and carry on conversations from a PC. This use of a PC to initiate telephone calls feels unnatural to most users who are accustomed to making calls from their cordless or corded POTS telephone. A more important drawback is that conventional VoIP requires the called party to be continuously logged on to his or her internet service provider (ISP) to receive notification of incoming calls. Some internet service providers charge customers based on usage of time, which may cause a party to incur increased expenses when implementing this type of internet telephony.

Another development in the telecommunications industry is the continued growth of broadband connections to the internet. Broadband data communications offer higher speed data communications than conventional dial-up connections. Typically, broadband connections between residential and/or office settings and the internet are accomplished by use of a cable modem or a digital subscriber line (DSL). While other forms of broadband exist, such as satellite connections, these two represent the largest segment of the market. Broadband still remains, however, a minor segment of all internet connections. Most users still connect to the internet using dial-up connections via standard modems and a PSTN.

Broadband allows connected users to quickly transfer large data packets over the internet. As a result, data files typically considered too large for such transfer, such as multimedia files, are being transferred over the internet at an increasing rate.

In an attempt to leverage this increased bandwidth, some broadband service providers, such as ISPs, are attempting to provide internet telephony service to their subscribers. Most providers, however, take an “all or nothing” approach in their offerings, requiring all calls, including local calls, to be sent over the internet. This arrangement has several drawbacks. For example, one benefit of the POTS is that the system provides a lifeline to the user even when local electrical power is lost because the POTS carries its own voltage. This allows a user to use their POTS telephones even during power outages. With the all or nothing broadband approach, this lifeline is lost unless the provider includes power supplies at strategic locations in the network.

A few switching devices have been proposed to take advantage of the increased availability of broadband connectivity. For example, U.S. Pat. No. 5,563,938 to Soshea, et al. for a SUBSCRIBER TELEPHONE DIVERTER SWITCH describes a device that switches between a LEC connection for local calls and a broadband connection to an IXC for long distance telephone calls. Unfortunately, this switching device still relies on the traditional phone network by its use of IXC's. As another example, U.S. Pat. No. 6,141,341 to Jones, et al. for a VOICE OVER INTERNET PROTOCOL TELEPHONE SYSTEM AND METHOD describes a gateway device that arbitrates between standard PSTN and VoIP calls. In this device, a user dials a VoIP call by entering a predetermined signal to signify a VoIP call (such as a “#” symbol), and then dials an internet address. The VoIP call is then routed over the internet as a “non-standard” PSTN call via a broadband connection. This device has several drawbacks. For example, it requires users to remember and dial internet protocol (IP) addresses, a system which most users are unfamiliar. IP addresses for user internet-connected computers are frequently assigned on a rolling, or as-needed basis. Thus, a called party may have a different IP address each time they connect to the internet, effectively complicating the use of this device. Also, this device requires that the calling party to signify a VoIP call by entering a signal. Furthermore, the device only allows for broadband connection to the internet, which renders the device useless for the majority of users who still connect to the internet via a dial-up connection over a PSTN. Lastly, because the device requires a user to dial an IP address, the device perpetuates, rather than obviates, several problems currently associated with VoIP, such as those described above. For example, the called party must receive the call at a computer assigned to that particular IP address.

Accordingly, there is a need for an internet telephony device and method that operates in a transparent manner to the users. Considering the drawbacks of the prior art, including those discussed above, there is a need for an internet telephony device that allows both dial-up and broadband connection to the internet for toll calls, including long-distance calls. Also, there is a need for a device that allows users, including both calling and called parties, to utilize their existing POTS devices in a familiar manner. Furthermore, there is a need for an internet telephony device and system that utilizes the newly emerging internet telephony service providers (ITSPs), commonly referred to as the “next generation telcos.” These providers terminate internet telephony calls, regardless of their origin, and send them over an appropriate PSTN in a manner that may offer a cost savings over traditional IXCs.

### SUMMARY OF THE INVENTION

The present invention provides an internet telephony device and system that operates in a transparent manner to the users, including both the calling and called parties.

In one embodiment, the device comprises a gateway that automatically detects the type of call being made, i.e., a local or toll call, and routes the call accordingly. For local calls, the device routes the call to the appropriate PSTN in a conventional manner. For a toll call, such as a long distance telephone call, the device routes the call to a computer network, such as the internet, via an available broadband or dial-up connection. Once on the internet, the call is routed by various service providers and routers, and can be routed according to least cost, quality of service, or other parameters. Ultimately, the call is routed to an ITSP for call termination and delivery via an appropriate PSTN.

The gateway device allows both users, i.e., the calling and called parties, to utilize their existing POTS devices in a conventional manner. Thus, both parties use existing telephones, obviating the need for special equipment. Also, both parties utilize their existing telephones in a conventional manner. Thus, the caller dials local and long distance calls in the manner he would have made the calls had the device not been present.

The device can include a unique identifier that distinguishes it from all other similar devices, such as a serial number. During set up or other times, a user can associate the identifier with information relating to the user, such as geographical locator. This enables a telephony system to route calls made from the device based on certain parameters, such as least cost for the distance between the calling and called parties.

When placing any phone call, local or toll, the user need not enter a special signal, such as the “#” symbol, and need not dial unfamiliar destination codes, such as IP addresses. As a result, the device is truly transparent to the user.

The present invention also provides methods of facilitating a telephone connection over the internet. In one method according to the invention, a service provider routes a specific call to one of a plurality of ITSP's based on certain parameters and information relating to the user that is associated with an identifier of the originating internet telephony device. For example, the service provider can route a call to a specific ITSP for termination and delivery through an appropriate PSTN based upon least cost for the distance between the calling and called parties. The distance can be calculated based upon geographical information associated with the identifier of the originating internet telephony device, such as area code or postal code, and geographical information associated with the called party, such as the area code of the dialed number.

While the invention is described in the appended claims, additional understanding of the invention can be gained from the following detailed description of the invention with reference to the appended drawings.

### BRIEF DESCRIPTION OF THE DRAWINGS

FIG. 1 is a schematic illustrating the connection of an internet telephony device according to the present invention to conventional POTS phones, a PSTN, and the internet.

FIG. 2 is a schematic of an internet telephony device according to a preferred embodiment of the present invention.

FIG. 3 is a schematic illustrating an internet telephony system according to the present invention.

FIG. 4 is a flow diagram illustrating a set-up procedure of an internet telephony device according to the present invention.

FIG. 5 is a block diagram illustrating a unique identifier of an internet telephony device according to the present invention and associated information relating to the user of such device as a call originator.

FIG. 6 is a flow diagram illustrating a preferred method of facilitating a telephone connection over the internet according to the present invention.

FIG. 7 is a flow diagram illustrating a preferred method of routing a telephone call made through an internet telephony device of the present invention.

### DETAILED DESCRIPTION OF THE INVENTION

The following description of preferred embodiments and methods provides examples of the present invention. The embodiments discussed herein are merely exemplary in nature, and are not intended to limit the scope of the invention in any manner. Rather, the description of these preferred embodiments and methods serves to enable a person of ordinary skill in the relevant art to make, use and perform the present invention.

The present invention provides an internet telephony device that operates as a gateway in a transparent manner to allow a user to place calls over a computer network, such as the internet. The device selectively routes local calls through a convention local connection, such as by a LEC, and toll calls, such as long distance calls, across the computer network.

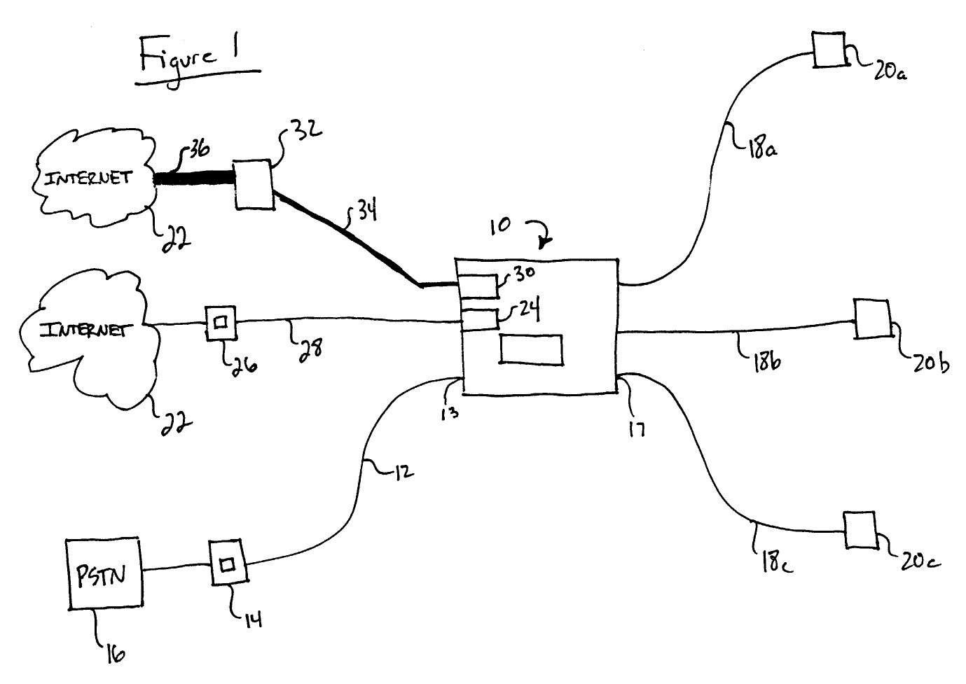

FIG. 1 illustrates an internet telephony device, or gateway 10, and its various connections. As illustrated in the Figure, the gateway 10 has a first standard twisted pair phone line 12 that plugs into a standard phone jack, or RJ-11 phone jack 14, and a standard telephone port 13 in the gateway 10. The phone line 12 is preferably a standard two or four wire service line typically used with analog POTS phones. The phone jack can be any phone jack in the user's home or office that is connected to the external PSTN 16. This connection allows the gateway 10 to route local phone calls to an appropriate PSTN 16 in the conventional manner.

Importantly, the connection to the PSTN 16 through the first phone line 12 and RJ-11 jack 14 provides a default phone service. This connection always enables the user to make local phone calls. This becomes important when electrical power is lost, which can prevent components, such as broadband modems and the gateway, from functioning. As a standard phone line, the first phone line 12 carries its own voltage, and therefore enables the use of POTS phones 20a-20c when main electricity is lost. The internal circuitry of the gateway, as will be developed more fully below, allows all phone calls, including local and long distance phone calls, to pass through the device in the event of a loss of electricity. These calls then connect to the PSTN in the conventional manner (internet routing is not available). As such, the gateway allows lifeline support, including access to emergency services, such as 911 and E911 service.

The gateway 10 includes at least one additional conventional telephone port 17. One or more additional phone lines 18a-18c are connected to the one or more ports 17 and to one or more analog POTS phones 20a-20c in the home or office. Again, phone lines 18a-18c are preferably conventional two or four wire service lines. Also, while the Figure illustrates three individual phone lines 18a-18c separately attached to the gateway 10, it will be readily understood that a single phone line can be branched in the conventional manner and connected to multiple POTS phones.

The POTS phones 20a-20c can be any conventional analog POTS device. For example, the POTS phones can be a touch tone phone, a rotary dial phone, a cordless phone, or a fax machine. Also, any number of POTS phones can be connected to the gateway through direct connections, a branching arrangement, or a combination thereof. Furthermore, multiple phone lines, e.g., multiple phone numbers, can be utilized. Most currently installed telephone wiring will support up to two different phone lines. Accordingly, the number of phone lines handled by the gateway is preferably two or less.

As indicated above, the gateway 10 selectively routes local phone calls to the appropriate PSTN 16 via the first phone line 12. Also, the gateway 10 selectively routes toll calls, such as long distance calls, to a computer network, such as the internet 22. The gateway 10 includes components that enable two different types of connections to the network. First, the gateway contains a conventional PC modem 24 that connects to the first phone jack 14 via first phone line 12, or to a second RJ-11 phone jack 26 via a second standard phone line 28. This connection enables the gateway 10 to connect to the internet 22 via a standard dial-up connection to an ISP (not specifically illustrated in FIG. 1).

In addition to the dial-up capabilities provided by the internal modem 24, the gateway also includes a network interface 30, such as an Ethernet 10/100 Base-T network interface card, that allows the gateway to be connected to a broadband access point 32, such as a cable modem or DSL modem. The network interface 30 connects to the gateway 10 and the broadband access point 32 via a conventional network connection 34, such as a Category 5E (CAT-5E) cable. The broadband access point 32 is connected to the internet via a conventional broadband connection 36, such as a coaxial cable, optical cable, or the like. Furthermore, any suitable type of broadband access point can be utilized, so long as it can be connected to the gateway 10 by network connection 34.

This provision of components that enable both dial-up and broadband connections to the internet allows the gateway to be utilized by essentially any user with internet access. Currently, most users access the internet via a conventional dial-up connection, while a minority utilize broadband connections. With the configuration discussed above, the gateway can be used by users with either type of internet access. Furthermore, a user who begins using the gateway with a dial-up connection but later switches his internet connection to broadband can utilize the gateway with both types of connections without needing to purchase a replacement gateway or replacement components. In this manner, the gateway represents an out-of-the-box, future compatible internet telephony solution for users.

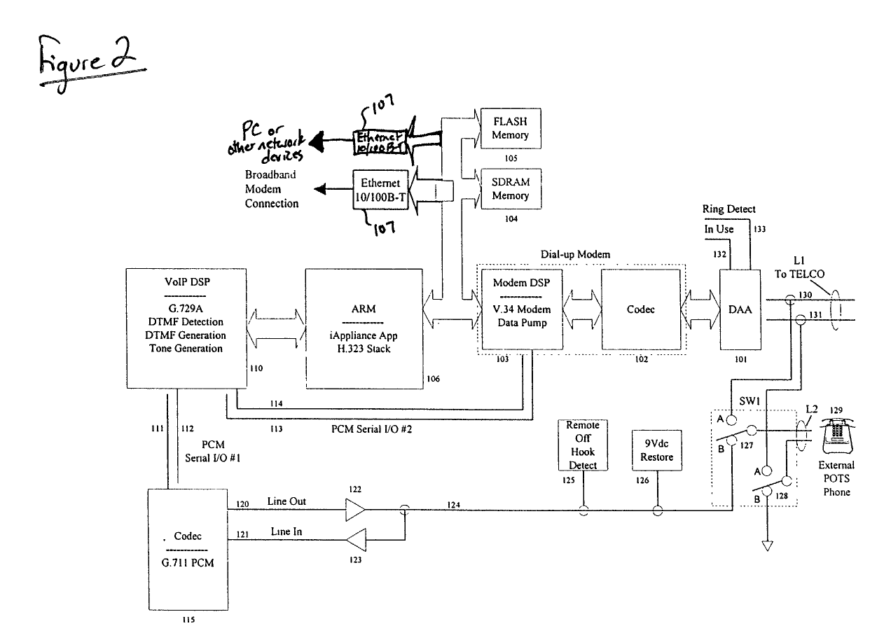

FIG. 2 illustrates a schematic of the operable components of the gateway 10 illustrated in FIG. 1.

FIG. 2 describes the internal architecture of the gateway device. The main components are a digital signal processor or DSP 110 and Microprocessor 106 such as an arm, a modem chip consisting of a Modem DSP 103 and Codec 102, a Data Access Arrangement or DM device 101, and a Codec 115. There is also program memory such as a Flash Memory device 105, random access memory device such as SDRAM 104, and one or more Ethernet Ports 107.

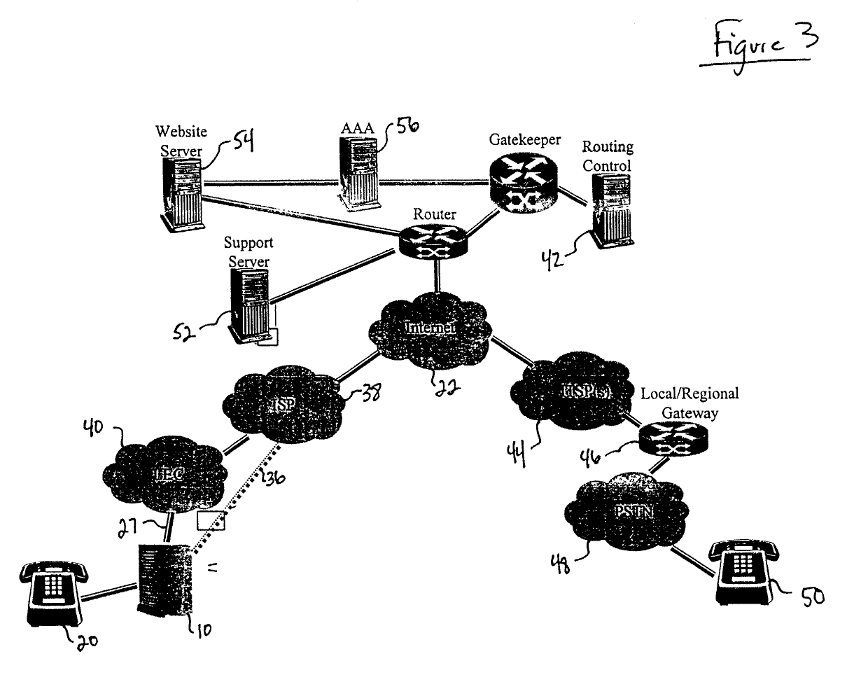

The following describes the sequence of operation for an outgoing call from the POTS phone 129 attached to the gateway. To use the gateway, there must be power to the gateway. If power is connected to the gateway, relay SWI is placed in the B position, connecting the POTS phone to the internal gateway circuitry. There is a DC voltage restore circuit 126 which provides power to the POTS phone to allow its operation. DC restore circuit derives its power from the gateway power source. Remote Off Hook Detection circuit 123 detects when the POTS phone goes off hook. The state of the Off Hook indication is sent to the ARM. The ARM Microprocessor looks at the In Use signal 132 generated by the DAA 101 to make sure no other phone connected to the L1 TELCO connection is presently using the telephone line. The ARM Microprocessor also looks at the Ring Detect Signal 133 generated by the DAA 101 to make sure no incoming call is presently occurring. The ARM Microprocessor then instructs the DSP 110 chip to send a simulated dial tone signal in digital formal to the Codec 113 which converts the digital simulated dial tone into analog format, which is then buffered by the Buffer 122 and sent to the POTS phone 129. A short time later, under normal situations, the user begins to dial telephone numbers on the POTS phone. These are tones generally in DTMF (dual tone, multiple frequency) format and are in analog format coming from the phone. The tones are buffered through Buffer 123 and input into the Codec 113 where they are converted from an analog format into a digital format, such as G.711 PCT (pulse code modulation) format. The DTMF codes which are the dial digits are sent to the DSP 110 where the DTMF codes are detected and decoded and the decoded DTMF signals are sent to the ARM Microprocessor 106. If instead, the user speaks into the POTS phone, the signals are ignored until a proper dial sequence is entered. Once the DTMF codes representing the dialing are entered, or enough of the digits to determine if there is a long distance or local call to be made, the ARM device decides whether to make a local call over the Telco L1 connection or long distance call over the Internet using either a dialup connection over L1 or a broadband connection over the Ethernet device 107. If a long distance call is to be made, it is done with gateway as previously described. If the user has a dialup connection, the ARM Microprocessor initiates a dial sequence to the local ISP through the Modem 103 and 102 by either providing the dial digits representing the ISP telephone number if the modem is capable of autodialing or DTMF tones if required. The modem interfaces to the telephone line through a Data Access Arrangement device 101. The modem can use either a V.34, V.90 or V.92 standard connect to the ISP. If the internet connection is to be a broadband connection, the connection to the ISP is made through the Ethernet device 107. One specific embodiment of the gateway might contain one Ethernet device, while another embodiment might contain two Ethernet devices. One Ethernet device is the broadband connection. In a specific embodiment where two Ethernet devices are used, the second Ethernet device can be used to connect to a PC or other device(s) with an Ethernet connection. This will allow the PC (or other device(s)) to share one broadband connection, as well as allow the gateway to prioritize voice packets from the gateway over data packets from the PC or other device(s). Once connection is made to the local ISP, the ARM Microprocessor sends the proper authentication information to the ISP, which is retained in the Flash Memory 105. Connection to a gatekeeper and authentication system as shown in FIG. 3 is then made and proper authentication and user specific information is sent. Additionally, the telephone number which is attempting to be dialed is passed to the gatekeeper. After the gatekeeper determines the best routing for an internet telephony call, an IP address of the local/regional terminating gateway as shown in FIG. 3 is passed to the gateway device. At this point, the local/regional terminating gateway and the gateway device pass information back and forth which specifies the specific protocols used at each end to handle the internet telephony calls such as the choice of compression code (G.723, G.729 or others) to be used. After this brief initiation sequence, the internet call is ready to proceed. The local/regional gateway initiates a call through the PSTN to a phone at the other end of the call, and after a very brief delay it begins to ring. The audio stream which contains the ringing, as well as the audio stream which contains the voice when someone at the other end picks up the phone passes between the modem 103 and the DSP 110 if the connection is dialup, or the Ethernet device 107, the ARM Microprocessor 106 and the DSP 110. The DSP converts the digital packets containing the voice segments as provided for in the compression codec (G.723, G.729 or another codec) back into uncompressed digital voice segments which in turn are passed to the Codec 115 which converts the digital uncompressed audio segment into analog formal to be sent to the POTS phone. The reverse of this process occurs for audio initiated on the POTS phone 129 when sent to the POTS phone on the termination side.

The following describes the sequence of operations for an incoming call into the gateway. If an incoming call occurs, the ARM Microprocessor receives a ring detect signal 133 from the DAA 101. A ring signal and voltage is sent to the POTS phone by the Remote Off Hook Detect and DC Restore circuitry 125 and 126. When a user picks up the POTS phone 129, an off hook detect signal is generated from circuit 125 and sent to the ARM Microprocessor. Audio signals from the POTS phone 129 flow through the buffer 123, and converted digital PCM stream by the Codec 115 and sent to the DSP 110. The DSP 110 passes this PCM stream via connections 114 and 115 to the modem chip 102 and 103 which with the DAA 101 converts this digital audio stream in PCM format back into analog format compatible with the connection L1 to the Telco. For an audio signal generated from the POTS phone on the termination end, the reverse of this process occurs.

If there is a power outage or other no power situation, relay SW1 128 connects the line L1 130 and 131 which is connected to the telephone company's (TELCO) line to the internal household wiring line L2 (127 and 128). Relay SW1 is in the A position. This allows the telephone company to provide lifeline and emergency services 911 and E911 support during a power outage or other no power situation.

FIG. 3 illustrates an internet telephony system according to the present invention. The figure illustrates the connection of the gateway 10 to the POTS phone(s) 20 of the home/office and various components of the internet 22.

The gateway 10 is connected to the internet 22 by either a broadband connection 36 or a dial-up connection 27, as described above. The broadband connection 36 represents a direct connection between the broadband access point (not illustrated in this figure) and the user's ISP. The dial-up connection 27, however, requires the use of an LEC 40 on the PSTN to make the connections, as is known in the art. Due to the direct connection and the relatively higher data transfer rate, the broadband connection is preferred. As detailed above, however, the gateway 10 has componentry that enables both connections 27, 36, and either can be utilized.

A routing control server 42 (RCS), which controls the routing of calls sent over the internet via the gateway 10, is connected to the internet 22. The RCS 42 is one or more computers that controls the routing of internet telephone calls from one or more gateways 10. As will be developed more fully below, the RCS 42 makes connections between an ISP and a desired ITSP 44 in order to facilitate a telephone connection over the internet. The ITSP is connected to one or more local regional gateways 46 that provide access to a local PSTN 48 connected to the POTS phone 50 of the called party.

In addition to the RCS 42, a provider who facilitates internet telephone connections in accordance with the present invention may also have additional servers connected to the internet 22. Examples of suitable additional servers include a support server 52 for facilitating automatic configuration of gateway device 10, a web server 54 for hosting a website containing information such as billing and customer support related information, and an authentication, authorization, and accounting server for verifying a user's right to utilize the service (i.e., the RCS 42), authenticating a gateway 10 and/or user, and generating accounting statements.

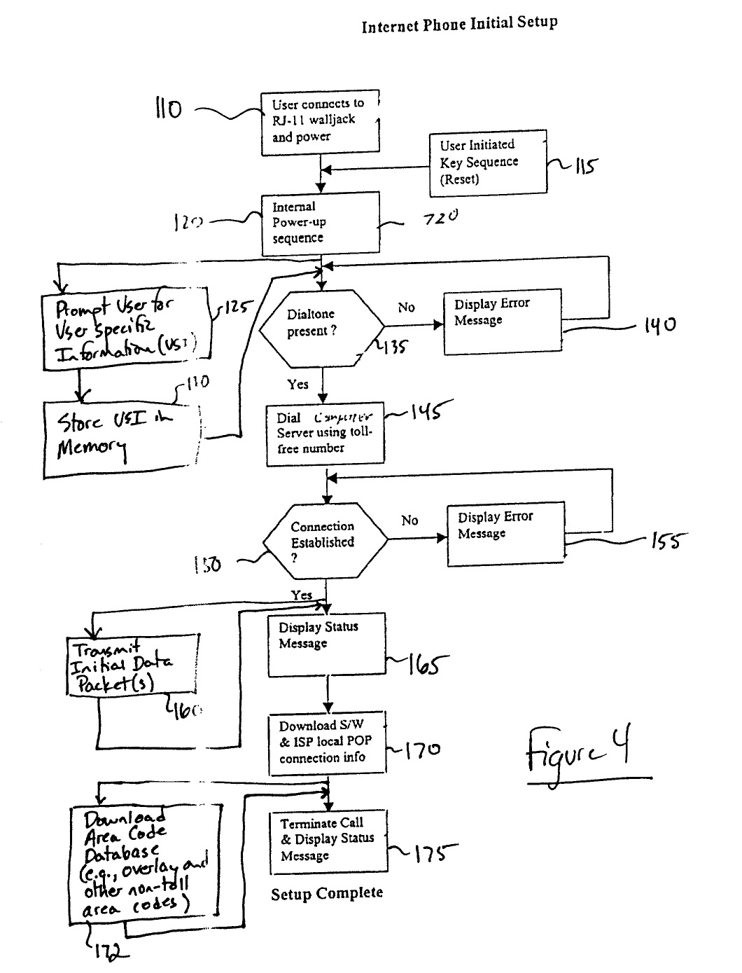

When a user initially connects a gateway to their home of office system, the gateway preferably automatically runs through an automatic configuration routine. FIG. 4 presents a flow chart of a preferred automatic configuration routine. A user connects the gateway to a RJ-11 phone jack and a power supply (step 110). On the initial establishment of these connections, the gateway automatically enters this routine. However, a user can always enter this routine by entering a code or other reset command (step 115). This may be desirable after a power loss or if a user wishes to change some user specific information, as is presented more fully below.

Once the routine is initiated, an internal power up sequence is initiated (step 120). In this sequence, the gateway may prompt the user to input selected User Specific Information (USI), which will be developed more fully below. The gateway stores the USI in memory (step 130) and may associate it with a unique identifier of the gateway. Next, the gateway checks for a valid connection to the POTS phone (step 135).

If a dial tone is not present an error message is displayed (step 140) and the gateway continues to check for a dial tone. If however, a dial tone is present, a web server is dialed, using, in an exemplary embodiment, a toll-free number (step 145). Once the web server is dialed, a check for the establishment of a connection is made (step 150). If the connection is not established an error message is displayed or indicated and the established connection is checked for again (step 150). If the connection is established, the gateway sends one or more initial packet(s) of data, consisting of, in an exemplary embodiment, a unique identifier of the gateway, revision of firmware, and other pertinent information (step 160). Also, the initial packet(s) may include the USI. A status message may be displayed (step 165). When a connection is established, the number from which the gateway 10 is calling is preferably established via called ID or some other means. A computer or web server will verify the unique identifier, check for a valid service plan activation, check for a valid revision of firmware, and any other appropriate checks. If new firmware is required, the gateway will download the updated firmware and store it (step 170). The computer or web server will also determine a local ISP point of reference (POP or calling location) and download that information into the gateway.

Also, the gateway can download a database of area code information that facilitates the selective routing of calls between the PSTN and computer network (step 172). For example, the database can comprise information relating to overlay area codes, i.e., area codes that overlay the same or similar geographic region as the area served by the area code of the POTS phones attached to the gateway, and other area codes that represent non-toll calls from the gateway, such as area codes in adjoining states. The database can be stored locally within the device and used when the gateway determines which path is chosen for a particular call. The RCS can maintain a regularly and/or frequently updated database of this area code information, ensuring that the gateway has access to current area code information. Upon completion of transfer of downloaded information to the gateway, the connection to the computer server will be terminated and a status message may be displayed (step 175). At this point the gateway is ready for normal operation.

The USI facilitates the routing of calls over the internet by providing information about the user that can be used in a process of selecting among various ITSPs. Various types of information can be included in the USI, and one or more pieces of information or data can be included in the USI. Preferably, the USI relates to various parameters that enable a choice between various ITSP's. Accordingly, the USI preferably contains information relating to the geographical location of the user. Examples of this type of data include postal codes, such as a United States zip code, telephone area code, and telephone country code. The information can be manually entered into the gateway during setup, as discussed above, or can be automatically detected, such as by taking the area code of the user's phone number by way of a caller ID unit.

Another type of information that can be included in the USI is the user's preference for quality of service from an ITSP. This would enable a routing decision based on various parameters relating to the quality of service provided by various ITSP's.

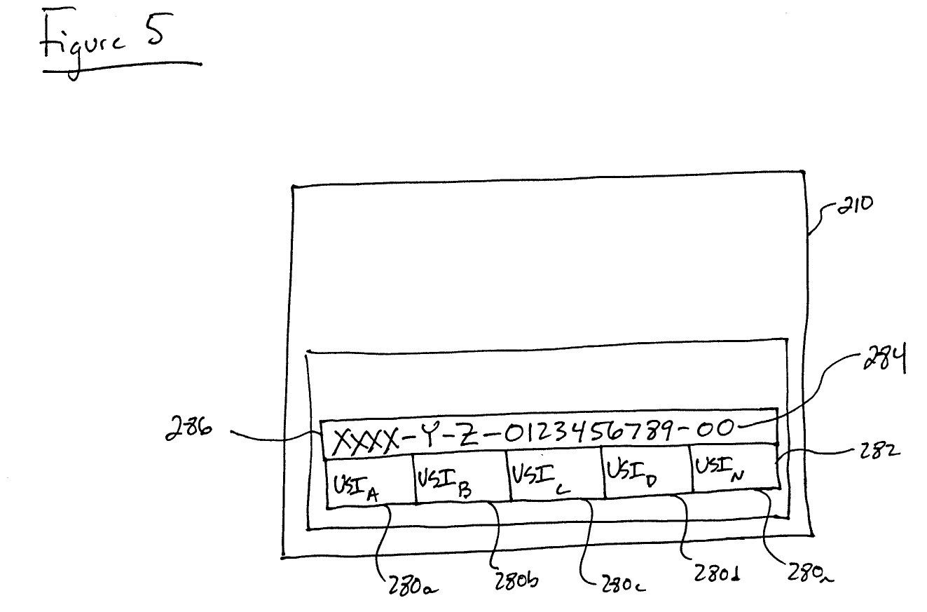

The gateway preferably stores the USI in memory. FIG. 5 presents a schematic of a preferred memory arrangement. As illustrated in the Figure, the various components of USI 280a-280n are stored in a memory module 282, such as a Random Access Memory (RAM) module or other suitable memory module. A unique identifier 284 of the gateway 210 is preferably stored in a non-volatile memory module 286, such as Read Only Memory (ROM). The unique identifier 284 is preferably a serial number or other code assigned by a manufacturer that distinguishes each gateway 210 from all other gateway devices. As indicated above, the gateway 210 can transmit the unique identifier and no, one, or more components of USI during the initial setup routine and in subsequent telephony sessions.

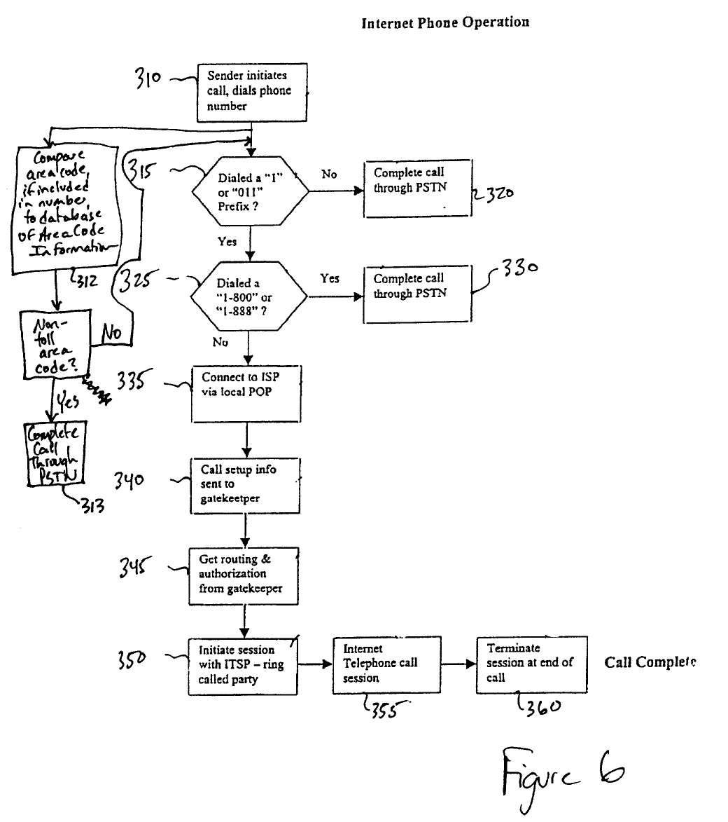

FIG. 6 presents a flow chart of a preferred method of facilitating a telephone connection over the internet. In a preferred method, the gateway device will operate using an internet telephony protocol, such as H.323, or another suitable protocol, such as SIP or MGCP, as appropriate. The use of the H.323 protocol enables the transmission of other data types, including, but not limited to, audio, text, video, and the like. For all calls, the gateway allows POTS phones to work in the conventional manner. For outgoing calls, a user dials a seven digit number for local calls, and a 1 plus a 10 digit number for domestic long distance calls. A 1 plus 7 digits can be used for local toll calls. Local calls that require ten digit dialing (e.g., phone numbers with overlay or adjacent area codes) are also dialed in the conventional manner—as a ten digit number.

The gateway preferably recognizes local area codes by consulting an internally stored database of area code information, such as information relating to overlay and other non-toll area codes. The gateway can download this database from the computer network, such as from a RCS. When a call that includes an area code is dialed on a POTS device attached to the gateway, the devices compares the area code of the dialed number to the area code information stored in the gateway (step 312). If the area code corresponds to a non-toll call (i.e., the area code is local, an overlay area code, or another non-toll area code, such as a geographically adjacent area code), the gateway connects to the local phone company via the POTS/PSTN connection (step 313). If a 1 (indicating a long distance or toll calls) or a 011 (indicating an international call) key sequence is depressed, and an included area code does not correspond to a non-toll area code, the gateway connects to the designated ISP by either the dial-up or broadband connection as appropriate. Toll-free calls can also be routed through the POTS/PSTN network (step 325) because the gateway recognizes sequences that indicate a toll-free call, such as “1-800” and “1-888.” If the call is a toll call, the gateway establishes a connection to the computer network via an appropriate ISP.

Once the connection to the ISP (step 335) is established, call setup information is transmitted in an initial data packet to a gatekeeper (step 340). A gatekeeper may be a dedicated or a general purpose web server which has software to determine the best routing criteria for the internet telephony call and transmit that information back to the originating ISP. The routing information can also be sent back to the gateway device for the duration of the call or for storage. The initial data packet transmitted may include a caller ID indication, the number to be called, along with other control parameters. Routing and authorization is provided by the gatekeeper (step 345). For example, the gatekeeper checks on account authorization before proceeding with the call. Once authorized, the gatekeeper establishes a connection between the gateway and the selected ITSP (step 350). Alternatively, the gatekeeper can transmit identifying information about the selected ITSP to the ISP so that the ISP can establish a connection to the ITSP. This connection establishes an internet telephony session between the calling and called parties. After the connection is established and the call control parameters negotiated (choice of CODECS, rates, etc.), data packets containing encoded voice information begin to be transferred in a duplex, or bi-directional, manner and the internet telephony call session is enabled (step 355). At some point in the telephone call, the call duration is determined by either user (on either end). Once the call is to be terminated, appropriate disconnection information is sent to the ITSP as specified in the H.323 protocol (or other suitable protocols), and the session is terminated at the end of the call.

Once the connection between the gateway and ITSP is established, the gatekeeper, or another computer, can monitor the connection for call quality parameters, such as number and/or frequency of lost data packets. This information can be used to update a database of ITSP's maintained by the gatekeeper or another computer.

The routing of the telephone connections made through the gateway device can be optimized on any number of parameters. For example, the gatekeeper, acting as a routing control server, can select an ITSP from a plurality of ITSP's based upon one or more parameters. These parameters can include, for example, the call completion cost. Furthermore, the parameters can include various historical and current quality of service parameters, such as call completion rate, number of lost data packets, voice quality, network delay and network congestion. A user can store their preferred parameters in memory in the gateway (see FIG. 5).

In a preferred method, the gatekeeper or routing control server maintains a database of ITSP's with indications of these various parameters for each ITSP. When connecting to the gatekeeper or routing control server, the desired parameters are passed to the gatekeeper or server for querying the database based on the parameter(s). The unique identifier of the originating gateway and any user-specific information, such as geographic locality—related information, can also be passed in order to facilitate the query of the database.

The gatekeeper or server queries the database based on one or more of the passed parameters, and selects an appropriate ITSP based on the results of the query.

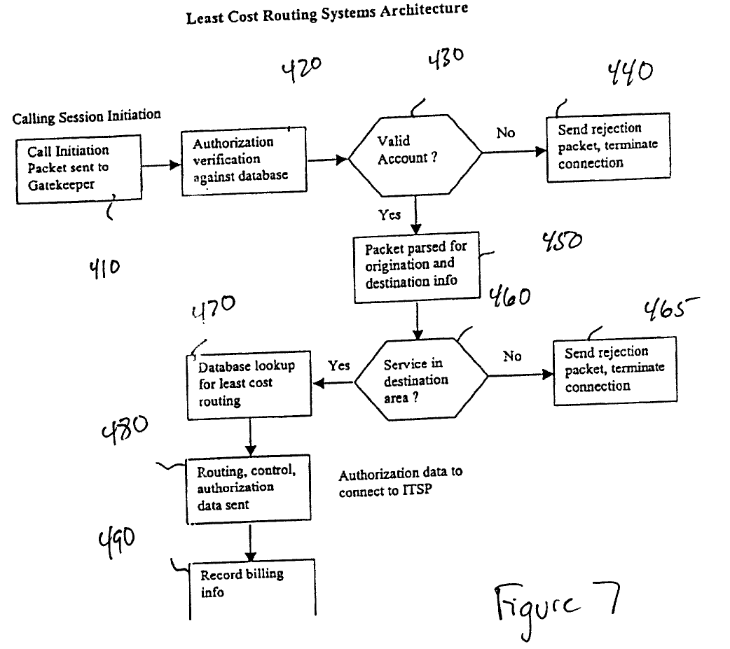

FIG. 7 illustrates a preferred method of this selection and routing process. A call initiation packet is sent to the gatekeeper service computer (step 410). When the packet is received by the gatekeeper computer, authorization or verification is checked against a database (step 420). The authorization and verification includes checking whether the account is valid (step 430). If there is no valid account on file a rejection packet is sent and the connection is terminated (step 440). However, if the account is valid, the packet is parsed to determine call origination and destination information (step 450). Once the packet has been parsed, a determination of whether there is service available in the destination area (step 460) is made. If there appears to be no service in the destination area a rejection packet is sent and the connection is terminated (step 465). If service is available in the destination area, gatekeeper computer queries the database to determine least cost routing information (step 470) or another appropriate selection criteria based on parameters passed to the gatekeeper by the gateway device. Once an ITSP determination is made, routing, control, and authorization data is sent to the appropriate ITSP (step 480). After authorization data is sent, the gatekeeper connects to the authorized ITSP and billing information is recorded for later use by the gatekeeper or server, or the ISP for billing the calling party for the call (step 490).

The foregoing disclosure includes the best mode devised by the inventors for practicing the invention. It is apparent, however, that several variations in the apparatuses and methods of the present invention may be conceivable by one skilled in the art. Inasmuch as the foregoing disclosure is intended to enable one skilled in the pertinent art to practice the instant invention, it should not be construed to be limited thereby, but should be construed to include such aforementioned variations.

I claim:

1. A telephone gateway device for selectively routing telephone calls between a local PSTN and a computer network, the device comprising:
a first telephone port adapted to connect to at least one POTS device;
a second telephone port adapted to connect to a standard telephone jack connected to said PSTN;
a modem adapted to establish a dial-up connection to said computer network;
a network interface device adapted to establish a broadband connection to said computer network;
a CODEC for encoding and decoding voice data relating to said telephone calls;
an internet telephony protocol for controlling internet telephone sessions on said computer network; and
a detection circuit including a microprocessor for detecting an initiation of a toll call on an attached POTS device and selectively routing the toll call to said computer network via either the modem or the network interface.

2. The telephone gateway device in accordance with claim 1, further comprising computer memory.

3. The telephone gateway device in accordance with claim 2, wherein the computer memory is ROM.

4. The telephone gateway device in accordance with claim 3, wherein the computer memory contains a unique identifier of said gateway device.

5. The telephone gateway device in accordance with claim 3, wherein the computer memory further comprises RAM adapted to receive and store information relating to a user of said gateway device.

6. The telephone gateway device in accordance with claim 1, wherein the circuitry is adapted to detect a toll call based upon the dialing of a “1” or “011” on an attached POTS device.

7. The telephone gateway device in accordance with claim 1, wherein the network interface comprises an Ethernet network interface card.

8. The telephone gateway device in accordance with claim 1, further comprising a data base of information relating to non-toll area codes relative to an area code of a phone number associated with the at least one POTS device.

9. The device in accordance with claim 1, wherein the CODEC is selected from the group consisting of ITU-T G.711, G.723, G.728, and G.729.

10. The device in accordance with claim 1, wherein the internet telephony protocol is selected from the group consisting of ITU-T H.323, SIP and MGCP.

11. A telephone gateway device for selectively routing telephone calls between a local PSTN and a computer network, comprising:
a first telephone port adapted to connect to at least one POTS device;
a second telephone port adapted to connect to a standard telephone jack connected to said PSTN;
a modem adapted to establish a dial-up connection to said computer network via said PSTN;
a network interface adapted to establish a broadband connection to said computer network;
means for transmitting and receiving voice data over said computer network; and
circuitry adapted to selectively route a toll call initiated on an attached POTS device to said computer network via either the modem or the network interface.

12. The telephone gateway device in accordance with claim 11, further comprising computer memory containing a unique identifier of said gateway device.

13. The telephone gateway device in accordance with claim 12, wherein the computer memory is adapted to receive and store information relating to a user of said gateway device.

14. The telephone gateway device in accordance with claim 11, further comprising a database of information relating to non-toll area codes relative to an area code of a phone number associated with the at least one POTS device.

15. A telephone gateway device for selectively routing telephone calls between a local PSTN and a computer network, comprising:
a first telephone port adapted to connect to at least one POTS device;
a second telephone port adapted to connect said gateway device to said PSTN;
a modem adapted to establish a dial-up connection between said gateway device and said computer network via said PSTN;
a network interface adapted to establish a broadband connection between said gateway device and said computer network;
an internet telephony protocol;
computer memory containing a unique identifier of said gateway device and adapted to receive and store information relating to a user of said gateway device; and
circuitry adapted to detect a toll call placed on an attached POTS device and selectively route the toll call to said computer network via either the modem or the network interface.

16. The telephone gateway device in accordance with claim 15, wherein the circuitry is adapted to detect a toll call based upon the dialing of a “1” or “011” on an attached POTS device.

17. The telephone gateway device in accordance with claim 15, wherein the network interface comprises an Ethernet network interface card.

18. The telephone gateway device in accordance with claim 15, wherein the internet telephony protocol is selected from the group consisting of ITU-T H.323, SIP and MGCP.

19. The telephone gateway device in accordance with claim 15, further comprising a database of information relating to non-toll area codes relative to an area code of a phone number associated with the at least one POTS device.

20. A method of facilitating a telephone connection over a computer network, said telephone connection originating from a POTS device; the method comprising,
receiving information relating to said connection from an ISP;
querying a database of ITSP's based on one or more parameters contained in the information;
selecting an ITSP from a plurality of ITSP's based on the querying; and
transmitting the identity of the selected ITSP to the ISP.

21. The method in accordance with claim 20, wherein the information includes a unique identifier of a telephone gateway device attached to said POTS device.

22. The method in accordance with claim 21, wherein the information further includes an indicator of the geographical location of said POTS device.

23. The method in accordance with claim 22, wherein the indicator is a postal delivery code, a telephone area code, or a telephone country code.

24. The method in accordance with claim 22, wherein the one or more parameters includes the call completion cost.

25. The method in accordance with claim 20, wherein the parameters include one or more of call completion rate, number of lost data packets, voice quality, and network delay.

26. The method in accordance with claim 20, further comprising monitoring a connection between the ISP and the selected ITSP that carries data relating to said telephone connection for lost data packets.

27. A method of selectively routing non-toll and toll telephone calls, comprising:
detecting a phone number dialed on a POTS device;
determining if an area code is present in the phone number;
comparing the area code to a database of information relating to non-toll area codes relative to the area code of the phone number;
connecting to a PSTN for transmitting said non-toll telephone call if the comparing indicates that the area code is a non-toll area code; and
connecting to a computer network for transmitting data relating to said toll telephone call if the comparing indicates that the area code does not correspond to a non-toll area code.
